(19) United States
(12) Patent Application Publication
(10) Pub. No.: US 2025/0352935 A1
(43) Pub. Date: Nov. 20, 2025

(54) WET-FLOW DUST EXTRACTION TOWER

(71) Applicant: Englo, Inc., Beckley, WV (US)

(72) Inventors: Timothy Wayne Warden, Asbury, WV (US); Gregory Michael Christian, Wayne, WV (US); Joseph Carl Finn, Greenville, SC (US); William Kelly Smith, Daniels, WV (US)

(21) Appl. No.: 18/664,351

(22) Filed: May 15, 2024

Related U.S. Application Data
(60) Provisional application No. 63/501,187, filed on May 10, 2023.

(51) Int. Cl. B01D 47/06

(52) U.S. Cl. CPC B01D 47/06

(57) ABSTRACT

A wet-flow dust extraction tower including a cylindrical shell with a tower inlet, and a top outlet, and further including a cone and scalping box positioned in a lower segment of the cylindrical shell, and a plurality of water nozzles positioned about the cylindrical shell. An air handling and cleaning system comprising a wet-flow dust extraction tower. A method of removing dust fines and fibrous material generated through industrial processes and released into the air, including capturing the air and the dust fines and fibrous material, and removing substantially all of the dust fines and fibrous material using a wet-flow dust extraction tower.

### FIELD OF INVENTION

Disclosed is a wet-flow dust extraction tower useful in removing fine dust and fibers, as a component of an air handling and cleaning system. Further disclosed is an air handling and cleaning system comprising a wet-flow dust extraction tower. Also provided is a method for removing fibrous material and dust particulate from a dirty airstream using a wet-flow dust extraction tower of the disclosed technology.

### BACKGROUND

Air handling and cleaning systems designed to capture flammable and combustible dust from metal recycling, tire shredding, agriculture, wood, coal handling and processing, and other processing applications, generally require special provisions for mitigating the possibility for combustion of fine particulate. These systems may include one or more hoods, fans, duct work, cyclones, dust extractors, and baghouses or other dust collectors.

However, fibrous materials presenting in the dust tend to form an entangled web, which plug or clog cyclones, baghouses and other collectors, and other dust control components in these systems. Fibrous dust can be long or short fibers created during manufacturing, handling, processing, or recycling of many materials.

Incorporating a wet-flow dust extraction tower of the disclosed technology to remove these fibrous materials, ahead of the final stage wet dust extractor in an air handling and cleaning system, overcomes these and other issues presented in the prior art.

### GENERAL DESCRIPTION

The disclosed wet-flow dust extraction tower is designed to collect and remove fibrous materials and fine particulates as a waste effluent. The waste effluent may then be dewatered in a water separation and recirculation system, or otherwise treated and/or disposed. A suitable water separation and recirculation system is disclosed in U.S. Pat. No. 9,675,915, issued Jun. 13, 2017, titled: Separator for Dewatering Particulate Matter Suspended in Water, the disclosure of which is incorporated herein by this reference. Air exiting the tower may be ducted into the inlet of a wet dust extractor which captures and removes remaining ultrafine particulates. Suitable wet dust extractors include those offered by Englo, Inc. (Beckley, WV), which have been independently verified at 99.7% removal of fugitive coal dust and are considered “best determined technology” for coal handling and processing. See, also, U.S. Pat. No. 10,022,662, issued Jul. 17, 2018, titled: Wet Dust Extractor with a Separator for Dewatering Particulate Matter Suspended in Water, the disclosure of which is incorporated herein by this reference.

The disclosed technology provides a wet-flow dust extraction tower including a cylindrical shell, with a tower inlet and a top outlet. The tower inlet is provided to receive and transport air comprising dust fines and fibers from the air handling components of an air handling and cleaning system, into the cylindrical shell. The top outlet is provided to expel air substantially free of dust fines and fibers from the cylindrical shell. In aspects, the cylindrical shell presents in three or more segments, a top segment, an upper segment a lower segment, and may include one or more additional intermediate segments. In this configuration, the top outlet presents as an aperture on the top segment, rectangular ductwork, or similar structure, and the tower inlet is secured about an opening on a lateral surface of the lower segment. The cylindrical shell further includes a cone centrally positioned within the lower segment.

A plurality of water nozzles are positioned about the top segment, and/or in any additional intermediate segment, and further about or extending from the lateral surface of the lower segment, to strategically supply water within the cylindrical shell. Further, secured on an interior lateral surface of and to the bottom surface of the lower segment may be a scalping box, with an open side in the flow path to capture wet dust fines and fibers as they circulate about the lower segment of the cylindrical shell, as hereinafter described. Alternatively, floor openings or an open configuration of the lower segment relative to a base segment may be provided. Through an egress aperture formed on the bottom surface of the lower or base segment, effluent comprising wet dust fines and fibers captured by the scalping box or in the base segment exits the cylindrical shell, through a drain affixed to an underside of the bottom surface of the cylindrical shell, below the egress aperture. The effluent may then be delivered to a container or a delivery line, for disposal or further processing.

The disclosed technology further provides an air handling and cleaning system comprising one or more hoods, ductwork, and a wet-flow dust extraction tower as herein described.

Additionally, the disclosed technology provides a method for removing fibrous material and dust particulate, the method comprising providing a wet-flow dust extraction tower as herein described, supplying an airflow of fibrous dust and particulate thereto, and capturing and removing fibrous material and fine particulate therefrom.

### DESCRIPTION OF THE DRAWINGS

These and/or other aspects will become apparent and more readily appreciated from the following description of the embodiments, taken in conjunction with the accompanying drawings of which:

FIG. 1 is a peripheral view of an embodiment of a wet-flow dust extraction tower of the disclosed technology.

FIG. 2 shows the independent components of the wet-flow dust extraction tower of FIG. 1, prior to assembly.

FIG. 3 is a peripheral view of the lower segment of the cylindrical shell of the embodiment shown in FIG. 1.

FIG. 4 is a peripheral view of an exemplary air handling and cleaning system, incorporating the wet-flow dust extraction tower of the disclosed technology.

FIG. 5 is a block diagram of an embodiment of a method of removing dust fines and fibers from air generated in industrial processing.

FIG. 6 is a peripheral view of an embodiment of a drain, useful in wet-flow dust extraction towers of the disclosed technology.

FIG. 7 is a peripheral view of an embodiment of a dewatering screw auger, useful in wet-flow dust extraction towers of the disclosed technology.

FIG. 8 shows the independent components of another embodiment of a wet-flow dust extraction tower of the disclosed technology, prior to assembly.

FIG. 9 is a peripheral view of the embodiment of a wet-flow dust extraction tower of FIG. 8, assembled.

FIG. 10 is a peripheral view of a portion of the top segment of the embodiment of a wet-flow dust extraction tower of FIG. 8.

FIG. 11 is a peripheral view of a portion of a water supply system of the embodiment of the wet-flow dust extraction tower of FIG. 8.

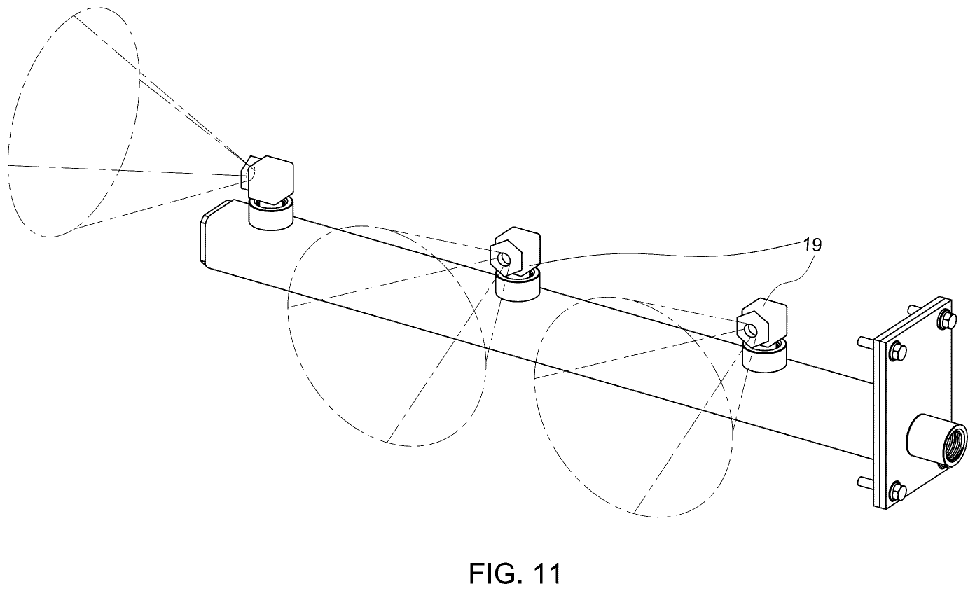

### DETAILED DESCRIPTION

Reference will now be made in detail to the embodiments, examples of which are illustrated in the accompanying drawings, wherein like reference numerals refer to like elements throughout.

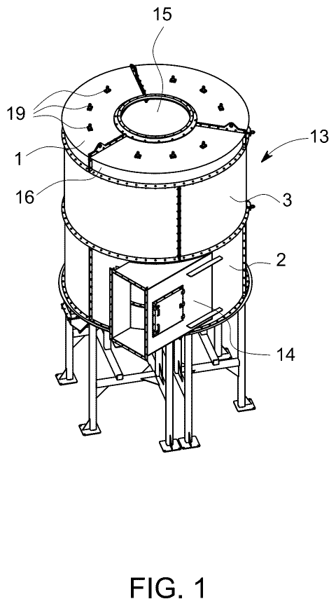

As shown in the embodiment of FIGS. 1, 2, 8 and 9, the wet-flow dust extraction tower of the disclosed technology comprises a cylindrical shell 13 with a tower inlet 14, and a top outlet 15. The tower inlet receives and transports air comprising dust fines and fibers into the cylindrical shell, and the top outlet expels air substantially free of dust fines and fibers from the cylindrical shell. The wet-flow dust extraction tower of the disclosed technology further includes a water supply system, comprising a plurality of water nozzles 19 positioned about cylindrical shell, to inject water into the shell, thereby wetting the dust fines and fibers for capture.

In the embodiment shown, the cylindrical shell 13 presents in three segments: a top segment 1, an upper segment 3 forming the upper portion of the cylindrical shell, and a lower segment 2 forming the lower portion of the cylindrical shell. Although shown in the figures as two independent segments of the cylindrical shell, the upper and lower segments (and any intermediate segments) may present as a unified or integral structure. Positioned about the lateral surface of one or more of the segments are access doors 42.

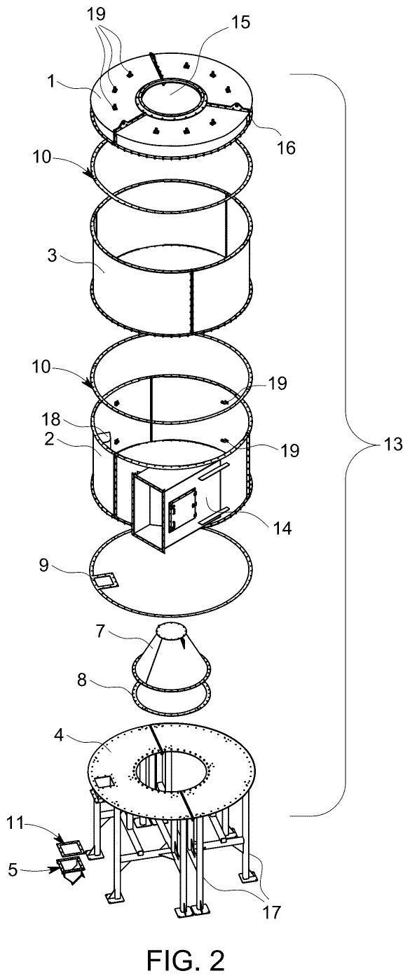

In the embodiment shown in FIGS. 1 and 2, positioned radially about the top surface of the segment are a plurality of the water nozzles 19. Further, the top outlet 15 may be centrally positioned on the top surface of the top segment. In the embodiment shown, the top segment further includes a collar 16 to removably secure the top segment to the upper segment, by means of corresponding threads, bolts, and apertures, or any other secure fit or means of affixation which may be released to remove the top segment from the upper portion of the cylindrical shell to facilitate cleaning and maintenance of the cylindrical shell.

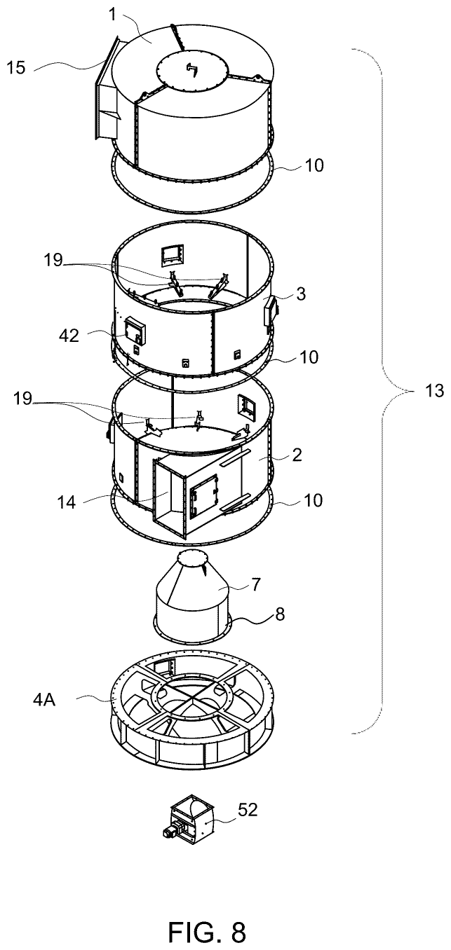

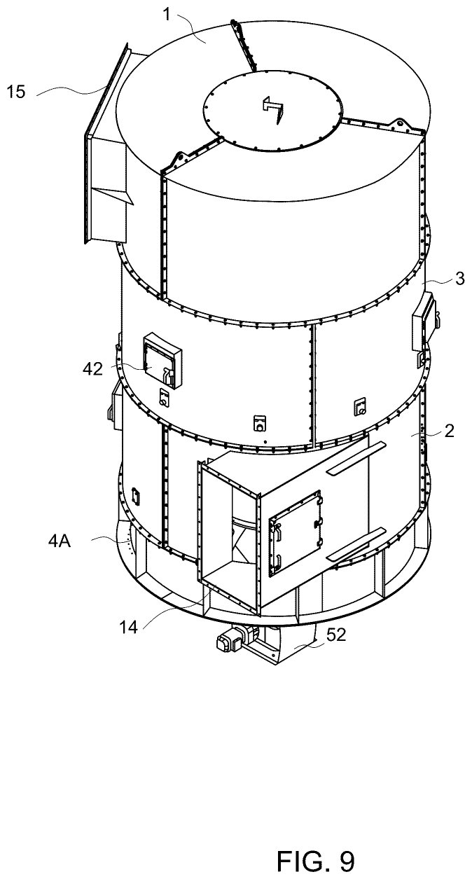

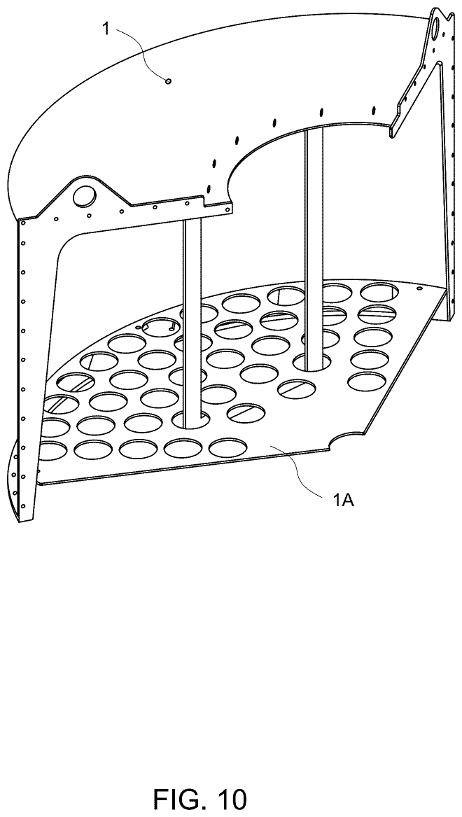

In the embodiment shown in FIGS. 8 and 9, the nozzles 19 may be supported on manifolds, extending from the interior sides of the upper and lower segments into the void within the shell. Further, as shown in this embodiment, the top outlet 15 may extend from a side of the top segment. As shown in FIG. 10, an air distribution baffle plate 1A, having a plurality of apertures, may be positioned within and secured about or near the bottom of the top segment, thereby limiting the air flow to the top outlet and maintaining the fibrous materials in the upper and particularly the lower segment of the cylindrical shell. Alternatively, this air distribution baffle plate may be positioned within the upper or an intermediate segment of the cylindrical shell. As shown in FIG. 10, the plate 1A may be partially secured to or supported by the top segment by means of one or more partial frames, with legs extending through two of the apertures, the legs being secured by a horizontal bar on the opposing side of the plate.

Positioned radially about the lower segment are another plurality of the water nozzles 19 of the water supply system. In the embodiment shown in FIGS. 1 and 2, the lower segment 2 is affixed to or comprises a bottom surface 4, which may be supported above the floor by a plurality of legs 17, extending from the bottom surface. Alternatively, in the embodiment shown in FIGS. 8 and 9, the lower segment may be affixed about its perimeter to a base segment 4A, which captures the wetted dust fines and fibers for delivery through an egress aperture into a cone hopper 52 or similar apparatus, and away from the cylindrical shell.

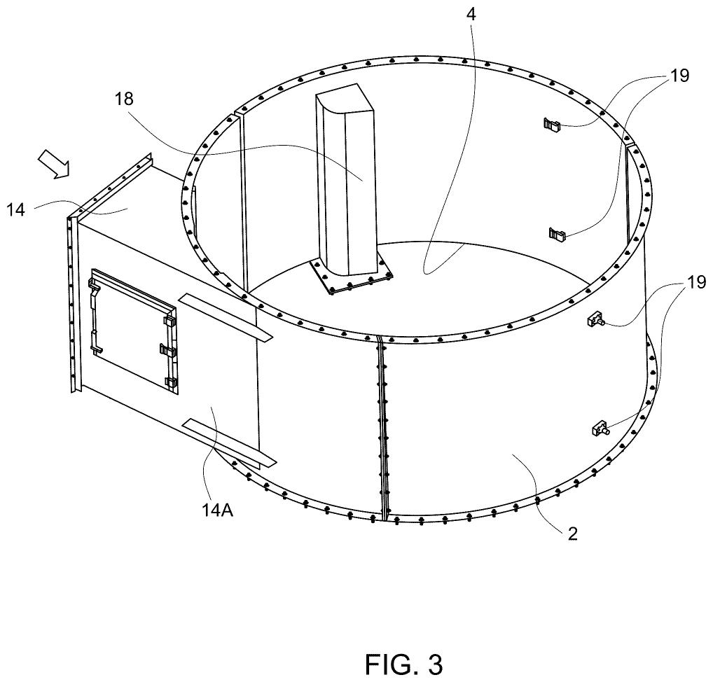

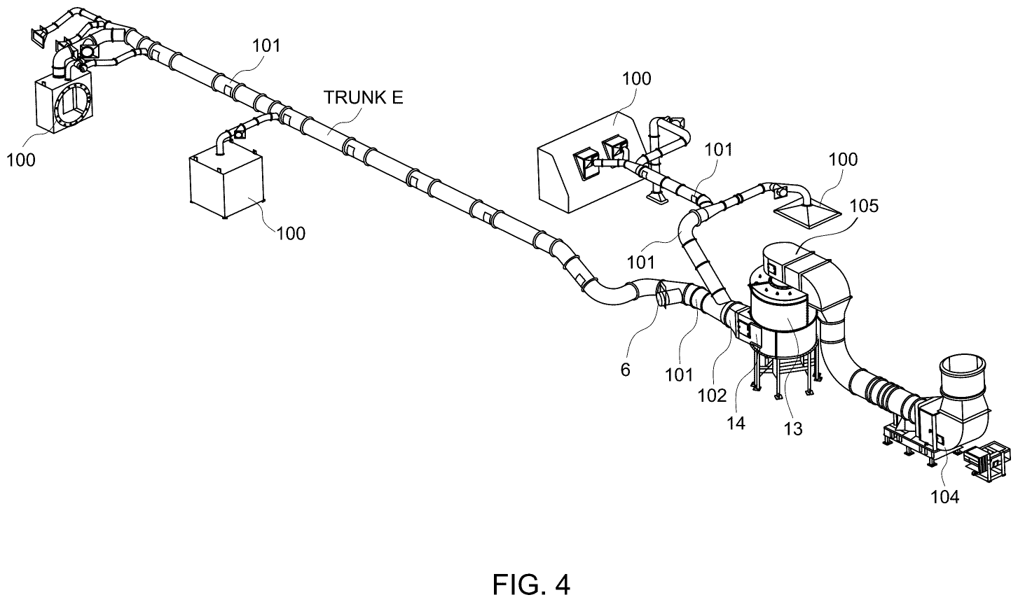

As shown in the embodiments of FIGS. 1-3, 8 and 9, the tower inlet 14 for receiving and transporting air comprising dust fines and fibers into the cylindrical shell, presents with a rectangular cross section and linear sides, with a first end that may be secured to ductwork of an air handling and cleaning system (by means of a round to rectangular transition, 102, for example, as shown in FIG. 4), and a second end secured about a corresponding rectangular opening on the lateral surface of the lower segment 2 of the cylindrical shell 13

. The tower inlet presents and extends from the lateral surface of the cylindrical shell, with its exterior side 14A extending perpendicular to the radius of the shell at the point of affixation, to cause the airflow to circulate about the axis of the circular shell. Airflow through the system is created by a centrifugal or axial fan 105 positioned near the top outlet side of the wet-flow dust extraction tower, which draws air from hoods and through ductwork to the tower inlet and into the wet-flow dust extraction tower.

As shown in the figures, truncated cone 7 is centrally secured to the bottom surface 4 or to corresponding support structure of the base segment 4A, to further facilitate the sweeping of air, water and material around the lower segment, and creating a high velocity turbulent flow path around the lower segment of the tower to capture the wetted fine particulate dust and fibers, while allowing a low uplift velocity of air. As shown in FIG. 8, the cone may have a cylindrical base. In embodiments, the base diameter of the cone may present as between one-half and three-quarters of the diameter of the cylindrical shell. The height of the cone may present as about the same as the height of the lower segment, or about the same as the height of the tower inlet.

The cylindrical shell diameter of the wet-flow dust extraction tower of the disclosed technology must provide sufficient airflow velocity to sling the wetted dust fines and fibers within the cylindrical shell as herein described, around the interior tower wall of the lower segment. Notably, an insufficient cylindrical shell diameter might cause the wetted dust fines and fibers to stick to the interior tower wall, or might cause the wetted dust fines and fibers to fall to the bottom surface of the embodiment of the tower shown in FIGS. 1 and 2. Incorporating a base segment with large openings around the perimeter, as shown in FIGS. 8 and 9, in conjunction with the truncated cone captures these fibers and fine dust settling at the bottom of the lower segment, for release to the cone hopper 52.

Appropriate tower diameter increases as needed to match the air volume received from the ventilation system. Typical airflow volume may be 6,000 cfm to 100,000 cfm, wherein a larger tower diameter is necessary as the air volume increases. For example, in a 34″ diameter cylindrical shell, airflow volume may average about 6,000 cfm; for a 72″ diameter cylindrical shell, airflow volume may increase to about 20,000 cfm, for a 120″ diameter cylindrical shell, airflow volume might increase to about 55,000 cfm, and for a 140″ diameter cylindrical shell, airflow volume might exceed 55,000 cfm.

Furthermore, the water spray from the nozzles 19 on the top or upper segments of the cylindrical shell serves to maintain a downdraft rain effect intended to wet dust fines and fibers, thereby causing them to remain circulating in the lower segment. Additional nozzles positioned on or extending from the lateral surface of the lower segment may further serve to wet dust fines and fibers in circulating about the lower segment. The nozzles may supply between 10 gpm to 100 gpm to the cylindrical shell, depending on the number and positioning of the nozzles, and the size of the cylindrical shell, the airflow volume, and the composition (volume of fine dust and fibers) of the incoming air. Importantly, insufficient water will fail to capture the dust fines and fibers; excessive water will cause the wetted dust fines and fibers to accumulate about the bottom surface of the cylindrical shell, causing capture issues in the embodiment of FIGS. 1 and 2.

In this configuration, with sufficient airflow, the tower inlet, the cone design, an air baffle plate, if any, and an effective amount of water spray about the cylindrical shell, incoming air slowly rises vertically within the cylindrical shell, while the water spray collects the fine particulate and fibers therein, thereby maintaining substantially all of the fine dust and fibers circulating about the lower segment of the cylindrical shell until removed. The exhausting airflow rising through the cylindrical shell through the top outlet is substantially devoid of dust fines and fibers, wherein only the very finest particulate dust might transport upwards through the top outlet of the wet-flow dust extraction tower.

In the embodiment of FIGS. 1 and 2, to capture and remove the wet dust and fibers circulating about the lower segment of the cylindrical shell, a scalping box 18 is secured along its length to the interior of the lower segment of the cylindrical shell, with the bottom thereof secured to the bottom surface of the cylindrical shell, about an egress aperture formed thereon, to allow captured wet dust fines and fibers to exit the cylindrical shell. An open side of the scalping box 18 presents in the flow path, to capture wet dust fines and fibers and water as they sweep about the interior walls of the lower segment of the cylindrical shell. In this configuration, all water along with captured dust fines and fibers continuously flushes through the scalping box and is removed through the egress aperture of the bottom surface of the cylindrical shell. In embodiments, the scalping box may have a height of about the height of the lower segment of the cylindrical shell, and/or about the same height as the height of the tower inlet.

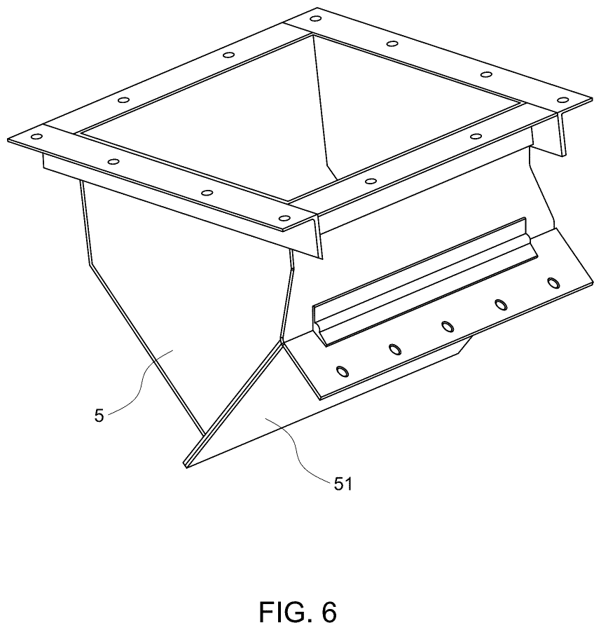

In this embodiment, the wet-flow dust extraction tower of the disclosed technology may further include a drain 5 (an embodiment of which is shown in FIG. 6), affixed to an underside of the bottom surface 4 of the cylindrical shell, below the egress aperture and aligned with the scalping box 18, through which the waste water including wet dust fines and fibers is delivered to a container or a delivery line, for disposal or further processing.

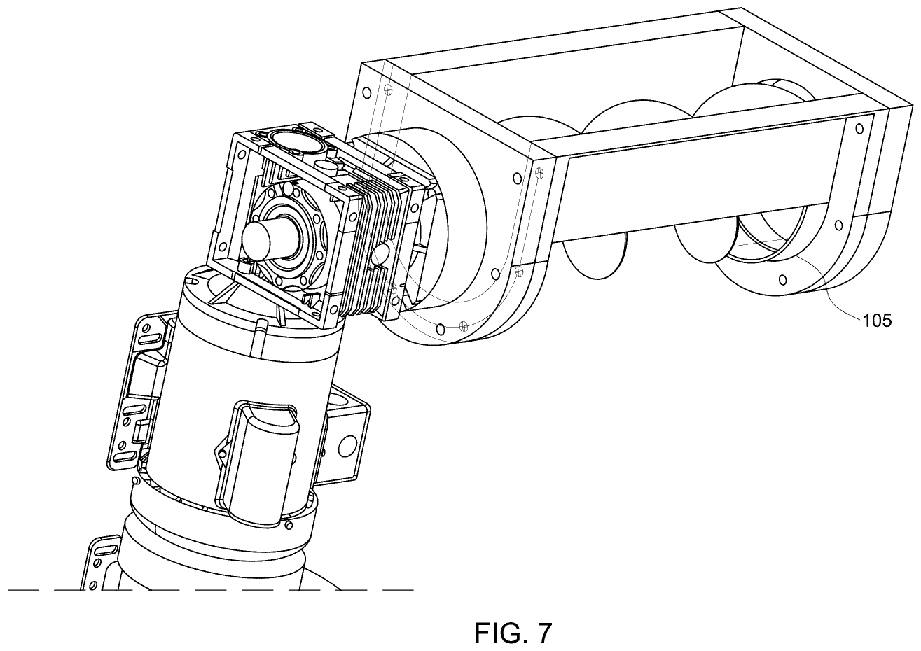

Importantly, the wet-flow dust extraction tower should be impervious to unwanted air flow and backdraft, as well as water leakage. Therefore, the drain opening may include a flange 51, inhibiting backdraft air leakage into the cylindrical shell, while allowing wastewater and wet dust fines and fibers to discharge. Similarly, the cone hopper 52 should be designed and affixed similarly to inhibit backdraft air leakage into the cylindrical shell. Alternatively, a dewatering screw auger 105, an embodiment of which is shown in FIG. 7, may be provided, designed to seal any backdraft air flow, while moving and separating water and fine and fibrous materials into a tank, receiving tote and/or other material handling device.

For like purposes, gaskets (e.g., 8, 9, 10, and 11, as shown in FIGS. 2 and 8), may and should be positioned between the segments and components of the wet-flow dust extraction tower of the disclosed technology to form a water-tight seal.

For purposes of transportation and installation, the various segments of the cylindrical shell may themselves present as segments, to be welded or otherwise affixed (water sealed) onsite.

As shown in FIG. 4, the wet-flow dust extraction tower of the disclosed technology is particularly useful in air handling and cleaning systems, wherein the dust fines and fibers are captured from process emissions via a plurality of hoods 100, and transported by ductwork 101 to the tower inlet 14 of the wet-flow dust extraction tower. The ductwork may connect with the tower inlet through a round-to-rectangular transition 102. Airflow through the system may be provided by one or more fans 105. As airflow is established within the wet-flow dust extraction tower, incoming air slowly rises vertically within the cylindrical shell, while the water spray collects the fine particulate and fibers therein, thereby maintaining substantially all of the fine dust and fibers circulating about the lower segment of the cylindrical shell until removed by means of the scalping box or through the cone hopper of the base segment. Exhausting airflow from the top outlet of the wet-flow dust extraction tower, substantially devoid of dust fines and fibers, may then be further ducted to a wet dust extractor 104, and finally into the environment.

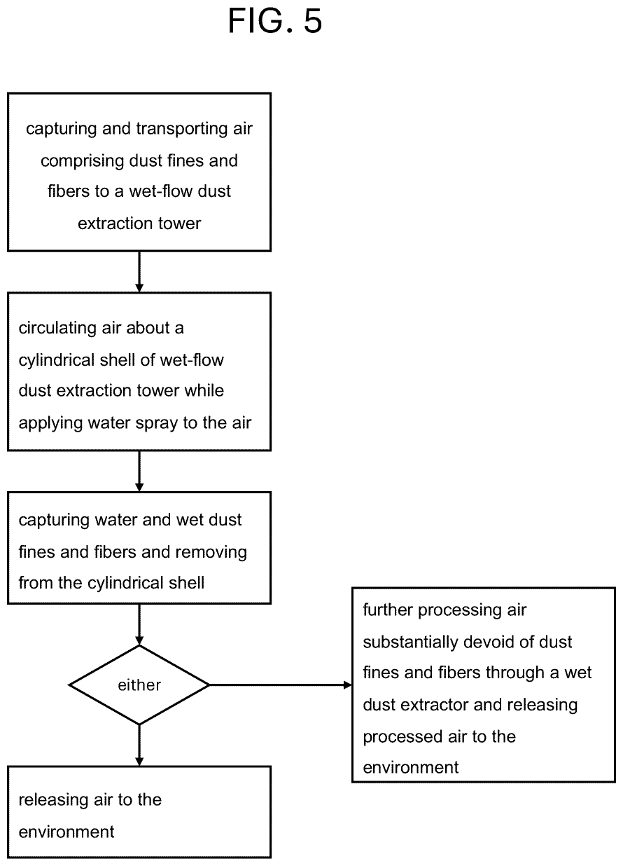

The disclosed technology further provides for a method of removing dust fines and fibers from air generated in industrial handling and processing applications, as depicted generally in FIG. 5. This method includes the steps of capturing and transporting air comprising dust fines and fibers to a wet-flow dust extraction tower as herein provided; circulating the air about the cylindrical shell while applying water spray to the air circulating within the cylindrical shell; and capturing the water and wet dust fines and fibers and removing the same from the cylindrical shell. The air substantially devoid of dust fines and fibers may then be further processed through a wet dust extractor, and released to the environment.

Although a few exemplary embodiments have been shown and described, it would be appreciated by those skilled in the art that elements of each embodiment may be incorporated into the other embodiments or combined for additional embodiments, wherein the elements are not exclusive to any one embodiment, and wherein changes may be made in these embodiments without departing from the principles and spirit of the invention, the scope of which is defined in the claims and their equivalents.

1. A wet-flow dust extraction tower useful in an air handling and cleaning system, the wet-flow dust extraction tower comprising:
a. a cylindrical shell with a tower inlet and a top outlet, wherein the cylindrical shell presents in three segments, a top segment, an upper segment and a lower segment, with a cone centrally positioned within the lower segment; wherein the tower inlet is secured to and about an opening on a lateral surface of the lower segment, with an exterior side presenting perpendicular to a radius of the cylindrical shell at a point of affixation;
b. a plurality of water nozzles positioned radially about or extending from a lateral surface of the lower segment; and
c. a scalping box, the scalping box being affixed along its length to an interior lateral surface of the lower segment of the cylindrical shell, and further to a bottom surface of the cylindrical shell, about an egress aperture formed on the bottom surface.

2. The wet-flow dust extraction tower of claim 1, wherein the plurality of water nozzles are also positioned radially about a top surface of the top segment.

3. The wet-flow dust extraction tower of claim 1, wherein the plurality of water nozzles are also positioned radially about the upper segment of the cylindrical shell.

4. The wet-flow dust extraction tower of claim 1, wherein the tower inlet presents with a rectangular cross-section.

5. The wet-flow dust extraction tower of claim 1, wherein the cone has a base diameter of between one-half and three-quarters of a diameter of the cylindrical shell.

6. The wet-flow dust extraction tower of claim 1, further comprising a drain affixed to an underside of the bottom surface and aligned with the egress aperture and the scalping box, with a drain opening comprising a flange to prevent unwanted air flow and backdraft into the cylindrical shell.

7. The wet-flow dust extraction tower of claim 1, further comprising dewatering screw auger for moving and separating water and fine and fibrous materials.

8. An air handling and cleaning system comprising one or more hoods, ductwork, and a wet-flow dust extraction tower, wherein the wet-flow dust extraction tower comprises:
a. a cylindrical shell with a tower inlet and a top outlet, wherein the cylindrical shell presents in three segments, a removable top segment, an upper segment and a lower segment, with a bottom surface to which is centrally affixed a cone; wherein the top outlet presents as an aperture on the top segment; and wherein the tower inlet is secured to and about an opening on a lateral surface of the lower segment, with an exterior side presenting perpendicular to a radius of the cylindrical shell at a point of affixation;
b. a plurality of water nozzles, positioned radially about or extending from the lateral surface of the lower segment; and
c. a scalping box, the scalping box being affixed along its length to an interior lateral surface of the lower segment of the cylindrical shell, and further to the bottom surface of the cylindrical shell, about an egress aperture formed on the bottom surface.

9. The air handling and cleaning system of claim 8, wherein the plurality of water nozzles are also positioned radially about a top surface of the top segment.

10. The air handling and cleaning system of claim 8, wherein the plurality of water nozzles are also positioned radially about the upper segment of the cylindrical shell.

11. The air handling and cleaning system of claim 8, wherein the tower inlet presents with a rectangular cross-section.

12. The air handling and cleaning system of claim 8, further comprising a drain affixed to an underside of the bottom surface and aligned with the egress aperture and the scalping box, with a drain opening comprising a flange to prevent unwanted air flow and backdraft into the cylindrical shell.

13. The air handling and cleaning system of claim 8, wherein the cone has a base diameter of between one-half and three-quarters of a diameter of the cylindrical shell.

14. A wet-flow dust extraction tower useful in an air handling and cleaning system, the wet-flow dust extraction tower comprising:
a. a cylindrical shell with a tower inlet and a top outlet, wherein the cylindrical shell presents in a plurality of segments, including a top segment, an upper segment, a lower segment and a base segment, with a cone centrally positioned within the lower segment and affixed to the base segment;
wherein the tower inlet is secured to and about an opening on a lateral surface of the lower segment, with an exterior side presenting perpendicular to a radius of the cylindrical shell at a point of affixation; and
b. a plurality of water nozzles positioned radially about or extending from a lateral surface of the lower segment.

15. The wet-flow dust extraction tower of claim 14, wherein the plurality of water nozzles are also positioned radially about a top surface of the top segment.

16. The wet-flow dust extraction tower of claim 14, wherein the plurality of water nozzles are also positioned radially from a lateral surface of the upper segment of the cylindrical shell.

17. The wet-flow dust extraction tower of claim 14, wherein the tower inlet presents with a rectangular cross-section.

18. The wet-flow dust extraction tower of claim 14, wherein the cone has a base diameter of between one-half and three-quarters of a diameter of the cylindrical shell.

19. The wet-flow dust extraction tower of claim 14, further comprising a cone hopper affixed to an underside of the bottom surface and aligned with an egress aperture of the base segment.

20. The wet-flow dust extraction tower of claim 14, further comprising dewatering screw auger for moving and separating water and fine and fibrous materials.
